(19) United States
(12) Patent Application Publication
(10) Pub. No.: US 2006/0234664 A1
(43) Pub. Date: Oct. 19, 2006

(54) Calibration method for suppressing second order distortion

(75) Inventors: Ching-Shiun Chiu, Hsinchu City (TW); Shou-Tsung Wang, Xinying City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Incorporation

(21) Appl. No.: 11/034,643

(22) Filed: Jan. 13, 2005

(51) Int. Cl. H04B 1/18; H04B 1/10

(52) U.S. Cl. 455/285; 455/302

(57) ABSTRACT

Calibration methods and circuits for suppressing second order distortion in a direct conversion receiver. In the calibration method, a signal output by a down converter is filtered to obtain an interference signal, and strength of the interference signal is detected. A calibration code is obtained according to the detected strength of the interference signal, and the down converter is adapted according to the calibration code to suppress second order distortion.

### BACKGROUND

The invention relates to direct conversion receivers (DCR), and more particularly, to method of calibrating second order (IP2) distortion in direct conversion receivers as well as a calibration circuit utilizing the same.

In a direct conversion receiver, radio frequency signals are converted directly into baseband signals, whereby separate intermediate frequency stages are not required. Thus, the number of high frequency components needed in direct conversion receivers is lower than in conventional receivers which include intermediate frequency stages. Due to lower complexity, the integration degree of direct conversion receivers can be increased compared to receivers including intermediate frequency stages.

However, receivers implementing the direct conversion technique have a smaller dynamic range than receivers which include intermediate frequency stages. The dynamic range is adversely affected by the fact that in addition to the high frequency signal of the reception channel, the mixer of the receiver also receives high frequency signals from adjacent channels, whereby a disturbing D.C. offset is produced at the mixer output due to the non-linear effect caused by the mismatches of the mixer. In practice, the degree of balance of a differential circuit is largely determined by how well the components comprising the circuit are “matched.” Thus, for example, to obtain a high degree of balance in a mixer one should construct the mixer using transistors that have substantially identical electrical properties and performance. However, due to limitations in semiconductor fabrication techniques, it becomes increasingly difficult to fabricate transistors with identical electrical properties as the physical size of the transistors decreases. Consequently, mismatches in the size of the various parts of the transistors may occur in many types of mixers. These mismatches may result in a significant increase in even-order non-linearity, and thus, a disturbing D.C. offset is produced at the mixer output and usually degrades the performance of the system in which the mixer is used. However, the stronger signals of adjacent channels can produce a substantially higher D.C. offset in the signal than desired signal expressed on the reception channel.

Attempts have been made to express the signal of the reception channel in spite of high interfering D.C. offset. However, these solutions only operate when the disturbing D.C. offset is constant or changes very slowly. When power of signals in the adjacent channels varies quickly, the disturbing D.C. offset changes accordingly, the prior art solutions cannot eliminates the disturbance fully. This is a typical situation in TDMA systems, for example.

U.S. Pat. No. 6,115,593 presents a method for eliminating D.C. offset which a correction signal is derived from the signal powers of the reception channels used, and is added to the signals demodulated from the signals of the received channel. However, when the DC offset is large, the demodulated signals may saturate the low-frequency amplifiers, therefore the output signal of each low-frequency amplifier is distorted. In such a case, it is no way for the correction signal to correctly compensated such a distorted signal.

U.S. Pat. No. 5,749,051 presents a compensation method for second order distortion in a homodyne receiver. This method utilizes a power detector to measure the total received power through the antenna bandpass filter. The instantaneous power measurements are fed to a signal processor along with complex baseband signals, where a complex compensation coefficient is determined by correlating the power signal with the complex baseband signals. The coefficient is then employed in subtracting a weighted amount of the power signal from the complex baseband signals in order to cancel the unwanted second order (IP2) distortion. However, the power detector is connected to the directional coupler and power consumption is large due to its operation at high radio frequency.

### SUMMARY

Embodiments of a calibration method suppressing second order distortion is disclosed, in which a signal output by a down converter is filtered to obtain an interference signal, and strength of the interference signal is detected. A calibration code is obtained according to the detected strength of the interference signal, and the down converter is adapted according to the calibration code to suppress second order distortion.

Also disclosed are embodiments of a calibration circuit suppressing second order distortion in a direct conversion receiver, in which a down converter down-converts a received signal and outputs a down-converted signal. A filtering unit coupled to an output of the down converter outputs an interference signal. A detection unit coupled to the filtering unit detects strength of the interference signal. A calibration code generator coupled to the detection unit generates a calibration code according to the detected strength. The calibration code is fed back to the down converter such that the down converter is adapted accordingly to suppress second order distortion.

### DESCRIPTION OF THE DRAWINGS

The invention can be more fully understood by the subsequent detailed description and examples with reference made to the accompanying drawings, wherein:

FIG. 1 shows an exemplary embodiment of a direct conversion receiver (DCR);

FIG. 2A shows an example of a received signal strength indicator (RSSI) detector;

FIG. 2B shows an exemplary circuit implementation of a rectifier;

FIG. 2C shows an exemplary circuit implementation of the summing unit;

FIG. 3A shows an embodiment of a calibration code generator;

FIG. 3B is an exemplary preset lookup table

FIG. 3C is another exemplary preset lookup table; and

FIG. 4 is a flowchart illustrating an embodiment of a calibration method suppressing second order distortion in a direct conversion receiver.

### DETAILED DESCRIPTION

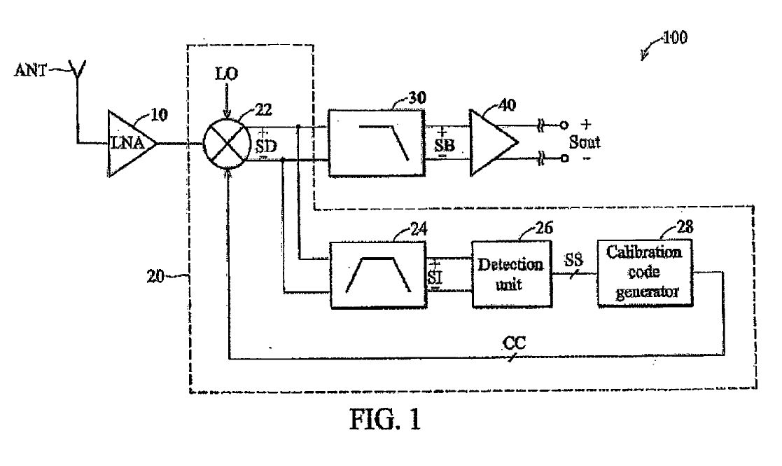

FIG. 1 is an exemplary embodiment of a direct conversion receiver (DCR) suppressing second order distortion. Specifically, direct conversion receiver 100 includes a calibration circuit 20 that suppress second order distortion according to down-converted signal output from a down converter 22.

As shown in FIG. 1, the direct conversion receiver (DCR) 100 comprises an antenna ANT, a low noise amplifier 10, a calibration circuit 20, a low-pass filter 30 and an amplifier 40. A radio frequency (RF) signal is directed via the antenna ANT and the low noise amplifier (LNA) 10 to the calibration circuit 20. The calibration circuit 20 coupled to the output of the low noise amplifier 10, comprises a down converter 22 to down convert the received RF signal to a down-converted signal SB, and generates a calibration code CC, according to the down-converted signal SB, to suppress second order distortion of the DCR 100. The down-converted signal produced by the down converter 22 is also directed to the low-pass filter 30, in which all other signals except baseband signal SB received is filtered away from the signal. The amplifier 40 receives and amplifies the baseband signal SB from the low-pass filter 30, and outputs a demodulated signal Sout.

As shown in FIG. 1, the calibration circuit 20 comprises the down converter 22, a filtering unit 24, a detection unit 26 and a calibration code generator 28.

The down converter 22 is coupled to the output of the low noise amplifier 10, down-converting the received RF signal from the low noise amplifier 10 to a down-converted signal, and can be adapted according to the calibration code CC to suppress second order distortion of the DCR 100. For example, the down converter 22 can include a tunable mixer, converting the received RF signal to a baseband signal according to a local oscillator frequency LO produced by an external local oscillator. Further, to suppress second order distortion of the DCR 100, the tunable mixer can be adapted to compensate interfering D.C. offset by adjusting parameters such as bias voltages, bias currents, load resistors and the like, according to the calibration code CC from the calibration code generator 28 such that the mismatch effect of the tunable mixer is reduced.

The filtering unit 24 is coupled to the output of the down converter 22, outputting an interference signal SI. For example, the filtering unit 24 comprises a bandpass filter to obtain a signal with a predetermined frequency, such as 1 MHz˜10 MHz, from the baseband signal SB, serving as an interference signal SI from adjacent channels.

The detection unit 26 is coupled to the output of the filtering unit 24, detecting the strength of the interference signal SI obtained by the filtering unit 24. For example, the detection unit 26 can be a means for detecting the strength of the interference signal SI obtained by the filtering unit 24, such as a received signal strength indicator (RSSI) detector, a power detector and the like.

The calibration code generator 28 is coupled to the detection unit 26, generating a calibration code according to the detected strength of the interference signal SI and outputting the calibration code CC to the down converter 22, such that the mismatch of the down converter 22 is reduced so as to suppress second order distortion of the DCR 100, according to the calibration code CC.

The down converter 22 converts the received RF signal to a baseband signal according to a local oscillator frequency LO and can be adapted to compensate component mismatch thereof by adjusting parameters such as bias voltages, bias currents, load resistors and the like, according to calibration codes, thereby suppressing second order distortion of a direct conversion receiver. The down converter 22 can be implemented by a tunable mixer such as that presented by Kalle Kivekäs et al. in “Calibration Techniques of Active BiCMOS Mixers,” IEEEJ. Solid-State Circuits, vol. 37, No. 6, JUNE 2002. Thus, the operations and structure are not described in this application for simplicity.

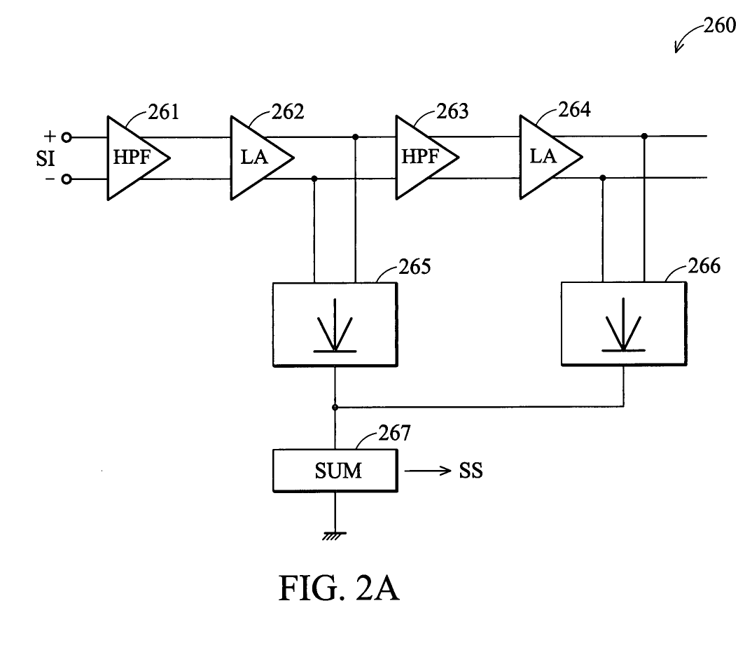

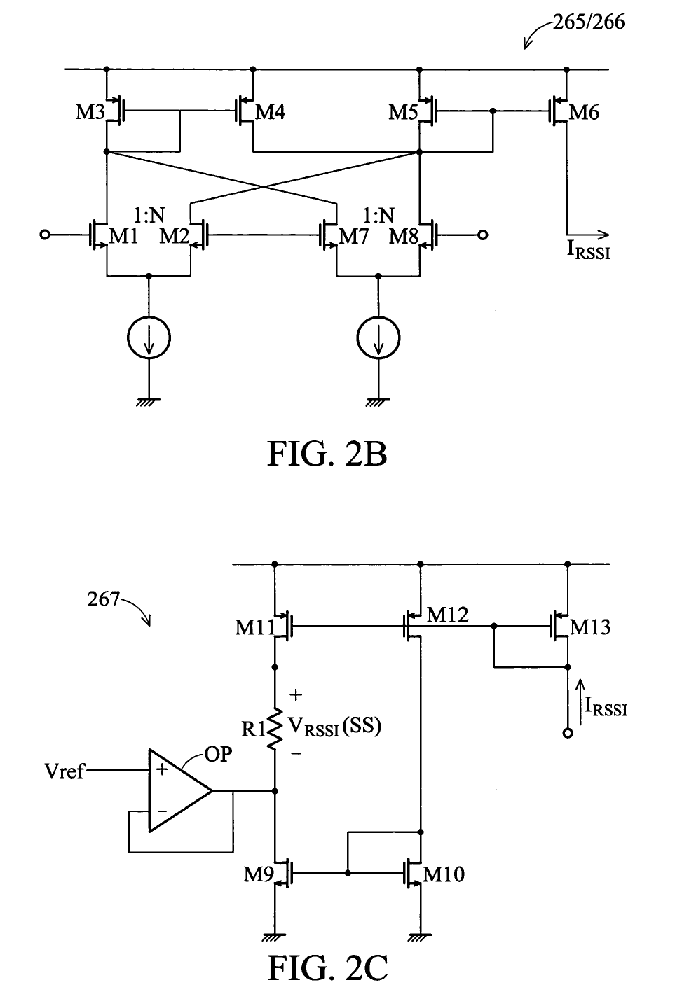

The detection unit 26 can be means for detecting the strength of the interference signal SI obtained by the filtering unit 24, such as a received signal strength indicator (RSSI) detector, a power detector and the like. FIG. 2A shows an example of a received signal strength indicator (RSSI) detector. The RSSI detector 260 comprises two high-pass filters 261 and 263, two limiting amplifiers 262 and 264, two rectifiers 265 and 266, and a summer 267. Inputs of the high-pass filter 261 are coupled to the filtering unit 24 to receive the interference signal SI, such that the rectifiers pick up signal swing and output corresponding current I_{RSSI} to the summing unit 267, generating a strength detection signal SS.

FIG. 2B shows a circuit implementation of the rectifiers 265 and 266, and FIG. 2C shows a circuit implementation of the summing unit 267. The rectifier 265/266 comprises MOS transistors M1-M8 and two current sources, in which gates of the MOS transistors M1 and M8 are coupled to the output of the limiting amplifier 262 or 264, such that the rectifier 265/266 generates a corresponding current I_{RSSI} according to the interference signal from the filtering unit 24. As shown in FIG. 2C, the summing unit 267 comprises MOS transistors M9-M13 and operational amplifier OP with a non-inversion terminal coupled to a reference voltage Vref, in which drain of the MOS transistor M13 is coupled to the corresponding current from rectifiers 265 and 266 such that the strength detection signal SS (V_{RSSI}) is generated on the resistor R1.

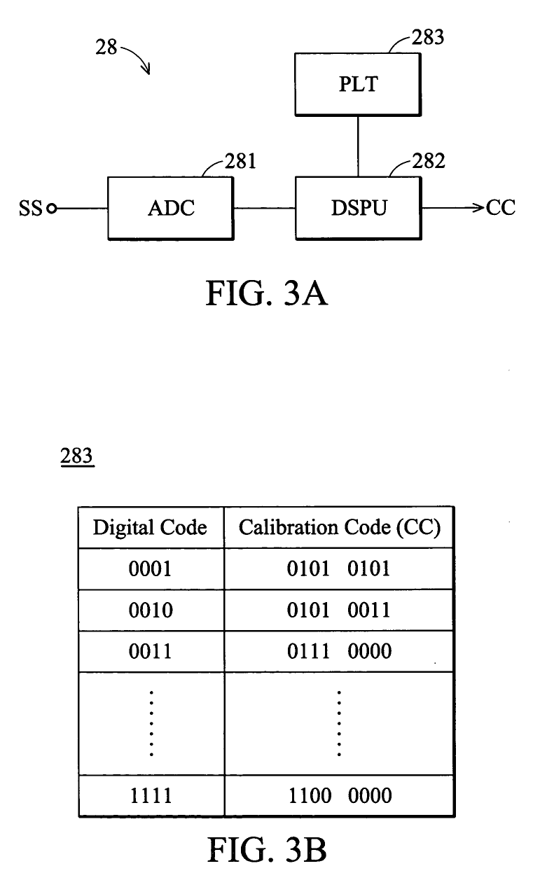

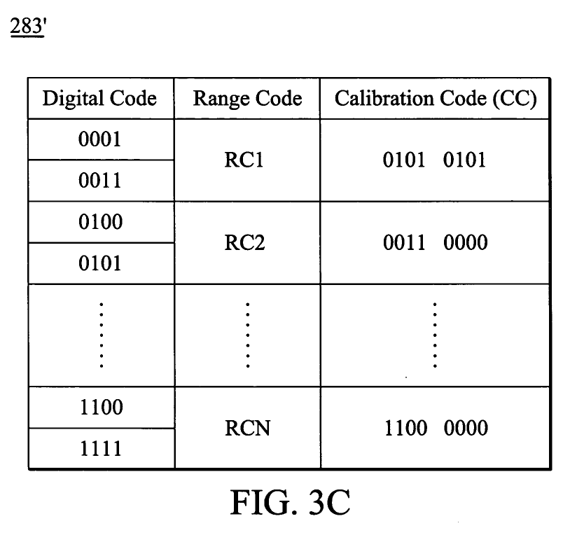

The calibration code generator 28 is coupled to the strength detection signal SS to generate a calibration code CC according thereto and output the calibration code CC to the down converter 22, such that mismatch of the down converter 22 is reduced so as to suppress second order distortion of the DCR 100 according to the calibration code CC. FIG. 3A shows an embodiment of the calibration code generator 28. As shown, the calibration code generator 28 comprises an analog-to-digital converter (ADC) 281, a digital signal processing unit 282 and a preset lookup table 283. The ADC 281 receives and quantizes the strength detection signal SS to output a digital code to the digital signal processing unit 282. For example, the ADC 281 can be an analog-to-digital converter with hysteresis properties. The preset lookup table 283 stores a plurality of digital codes and a plurality of calibration codes (CC), in which each digital code corresponds to one of the calibration codes as shown in FIG. 3B.

The digital signal processing unit 282 outputs a corresponding calibration code CC according to the digital code from the ADC 281 and the preset lookup table 238. For example, the digital signal processing unit 282 can utilize the digital code as an index into the preset lookup table 283 to obtain a corresponding calibration code CC. The corresponding calibration code CC is fed back to the down converter 22, such that the mismatch of the down converter 22 is reduced so as to compensate component mismatch thereof by adjusting parameters such as bias voltages, bias currents, load resistors of the down converter 22, according to the corresponding calibration code, thereby suppressing second order distortion of the direct conversion receiver 100. The preset lookup table 283 can be stored in an external storage unit, such as a nonvolatile memory, a read only memory (ROM), a mask ROM, a programmable ROM, an one time ROM, an erasable programmable ROM, an electrically erasable programmable ROM, a flash memory or the like.

FIG. 3C is another preset lookup table. As shown, the preset lookup table 283′ stores a plurality of digital codes, a plurality of range codes RC1-RCN and a plurality of calibration codes CC, in which each range code RC1-RCN corresponds to one of the calibration codes CC, and two digital codes correspond to one range code. For example, the digital signal processing unit 282 can utilize the range code as an index into the preset lookup table 283′ to obtain a corresponding calibration code CC in which the range code indicates the range the digital code from the ADC 281 falls within, in which the analog-to-digital converter ADC 281 can be a normal ADC without hysteresis properties due to the preset lookup table 283′. Although one range code corresponds to two digital codes in the preset lookup table 283′, it is to be understood that the invention is not limited thereto, one range code can also correspond to three, four or more digital codes.

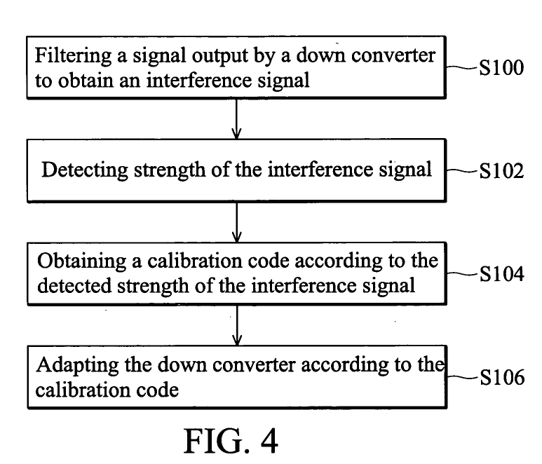

FIG. 4 is a flowchart showing an embodiment of a calibration method suppressing second order distortion in a direct conversion receiver.

In step S100, a signal output by a down converter is filtered to obtain an interference signal. A down-converted signal SB generated by a down converter 22 according to a received RF signal is filtered by a bandpass filter to output an interference signal SI. For example, the down converter 22 comprises a tunable mixer, converting the received RF signal to a baseband signal according to a local oscillator frequency LO produced by a local oscillator. The filtering unit 24 comprises a bandpass filter to obtain a signal with a predetermined frequency, such as 1 MHz˜10 MHz, from the baseband signal SB, serving as an interference signal SI from adjacent channels. Namely, the desired signal of the reception channel is filtered out to obtain the interference signal SI.

In step S102, strength of the interference signal is detected. The strength of the interference signal SI is detected by the detection unit 26, such as a received signal strength indicator (RSSI) detector, a power detector and the like, and a strength detection signal SS is then output.

In step S104, a calibration code is obtained according to the detected strength of the interference signal. The strength of the interference signal SI is detected by the detection unit 26 and output to the calibration code generator 28 comprising an analog-to-digital converter (ADC) 281, a digital signal processing unit 282 and a preset lookup table 283. The ADC 281 receives and quantizes the strength detection signal SS and outputs a digital code to the digital signal processing unit 282. The preset lookup table 283 stores a plurality of digital codes and a plurality of calibration codes (CC), in which each digital code corresponds to one of the calibration codes. The digital signal processing unit 282 outputs a corresponding calibration code CC according to the digital code from the ADC 281 and the preset lookup table 238. For example, the digital signal processing unit 282 can utilize the digital code as an index into the preset lookup table 283 to obtain a corresponding calibration code CC. The ADC 281 can be an analog-to-digital converter with hysteresis properties, and the preset lookup table 283 can be stored in an external storage unit, such as a nonvolatile memory, a read only memory (ROM), a mask ROM, a programmable ROM, an one time ROM, an erasable programmable ROM, an electrically erasable programmable ROM, a flash memory or the like. The calibration code CC generated by the calibration code generator 28 is then fed back to the down converter 22.

Alternatively, the preset lookup table 283′ can store a plurality of digital codes, a plurality of range codes RC1-RCN and a plurality of calibration codes CC, in which each range code RC1-RCN corresponds to one of the calibration codes CC, and two digital codes correspond to one range code as shown in FIG. 3C. The digital signal processing unit 282 utilizes the range code as an index into the preset lookup table 283′ to obtain a corresponding calibration code CC in which the range code indicates the range the digital code from the ADC 281 falls within, in which the analog-to-digital converter ADC 281 can be a normal ADC without hysteresis properties due to the preset lookup table 283′. Although one range code corresponds to two digital codes in the preset lookup table 283′, it is to be understood that the invention is not limited thereto, one range code can also correspond to three, four or more digital codes.

In step S106, the down converter is adapted according to the calibration code. The down converter 22 may not only convert the received RF signal to a baseband signal according to a local oscillator frequency LO, but also compensate for the component mismatch by adjusting some parameters, such as bias voltages, bias currents, load resistors and the like, so as to suppress second order distortion.

Thus, when receiving the calibration code CC, the down converter 22 is adapted to compensate component mismatch by adjusting parameters such as bias voltages, bias currents, load resistors and the like, thereby suppressing second order distortion of a direct conversion receiver. For example, the down converter 22 can be implemented by a tunable mixer such as that presented by Kalle Kivekäs et al. in “Calibration Techniques of Active BiCMOS Mixers,” IEEE J. Solid-State Circuits, vol. 37, No. 6, JUNE 2002. Thus, second order distortion of a direct conversion receiver is suppressed.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A calibration method for suppressing second order distortion in a direct conversion receiver, comprising:
filtering a signal output by a down converter to obtain an interference signal;
detecting strength of the interference signal;
obtaining a calibration code according to the detected strength of the interference signal; and
adapting the down converter according to the calibration code.

2. The calibration method as claimed in claim 1, wherein the down converter is a mixer.

3. The calibration method as claimed in claim 2, wherein the interference signal is obtained by bandpass-filtering the signal produced by the down converter.

4. The calibration method as claimed in claim 1, wherein obtaining the calibration code comprises:
quantizing the detected strength to generate a digital code; and
generating the calibration code according to the digit code and a preset lookup table.

5. The calibration method as claimed in claim 4, wherein the digital code is obtained by an analog-to-digital converter with hysteresis properties.

6. The calibration method as claimed in claim 4, wherein the calibration code is generated by the digital code as an index into the lookup table.

7. The calibration method as claimed in claim 4, wherein the calibration code is generated by a range code as an index into the lookup table, wherein the range code indicates the range the digital code falls within.

8. The calibration method as claimed in claim 1, wherein the detected strength of the interference signal represents a received signal strength indicator (RSSI).

9. The calibration method as claimed in claim 1, wherein the detected strength of the interference signal represents a power of the interference signal.

10. A calibration circuit for suppressing second order distortion in a direct conversion receiver, comprising:
a down converter, down-converting a received signal and outputting a down-converted signal;
a filtering unit coupled to an output of the down converter, outputting an interference signal;
a detection unit coupled to the filtering unit, detecting strength of the interference signal; and
a calibration code generator, coupled to the detection unit, generating a calibration code according to the detected strength;
wherein the calibration code is fed back to the down converter such that the down converter is adapted according to the calibration code.

11. The calibration circuit as claimed in claim 10, wherein the filtering unit comprises a bandpass filter.

12. The calibration circuit as claimed in claim 10, wherein the down converter comprises a mixer.

13. The calibration circuit as claimed in claim 10, wherein the detection unit comprises a received signal strength indicator (RSSI) detector.

14. The calibration circuit as claimed in claim 10, wherein the detection unit comprises a power detector.

15. The calibration circuit as claimed in claim 10, wherein the calibration code generator comprises:
an analog-to-digital converter (ADC), receiving the detected strength and outputting a digital code;
a preset lookup table; and
a digital signal processing unit, coupled to the ADC and the lookup table, outputting the calibration code.

16. The calibration circuit as claimed in claim 15, wherein the ADC comprises at least one comparator with hysteresis properties.

17. The calibration circuit as claimed in claim 15, wherein the calibration code is generated by the digital code as an index into the lookup table.

18. The calibration circuit as claimed in claim 15, wherein the calibration code is generated by a range code as an index into the lookup table, wherein the range code indicates the range the digital code falls within.

19. A direct conversion receiver, comprising:
a signal receiver, receiving a incoming signal;
a down converter, down-converting the received signal to a down-converted signal;
a bandpass filter coupled to an output of the down converter, outputting an interference signal;
a detection unit coupled to the bandpass filter, detecting strength of the interference signal; and
a calibration code generator coupled to the detection unit, generating a calibration code according to the detected strength;
wherein the calibration code is fed back to the down converter such that the down converter is adapted according to the calibration codes.

20. The direct conversion receiver as claimed in claim 19, wherein the detection unit comprises a received signal strength indicator (RSSI) detector.

21. The direct conversion receiver as claimed in claim 19, wherein the calibration code generator comprises:
an analog-to-digital converter (ADC), receiving the detected strength and outputting a digital code;
a preset lookup table; and
a digital signal processing unit, coupled to the ADC and the lookup table, outputting the calibration code.

22. The direct conversion receiver as claimed in claim 21, wherein the ADC comprises at least one comparator with hysteresis properties.
